(19) United States
(12) Patent Application Publication
(10) Pub. No.: US 2020/0050806 A1
(43) Pub. Date: Feb. 13, 2020

(54) Device for Placement in a Package of RFID Tagged Items to Improve Readability and Related Method

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 16/536,429

(22) Filed: Aug. 9, 2019

Related U.S. Application Data
(60) Provisional application No. 62/716,722, filed on Aug. 9, 2018.

(51) Int. Cl. G06K 7/10; G06K 19/07; G06K 19/06; G06Q 10/08

(52) U.S. Cl. CPC G06K 7/10346; G06Q 10/087; G06K 19/06028; G06K 19/0723

(57) ABSTRACT

A spacing device and related method for improving readability of a container of RFID tagged items that are in relatively close proximity to each other is disclosed. The spacing device is preferably a low dielectric constant spacing device, wherein the nature of the device can be varied to create different effects on the readability of the RFID tagged items by preventing them from occupying areas with a large amount of material between the RFID tagged items and the RF reader. The spacing device is added into the container as the RFID tagged items are loaded into the container, and is preferably positioned in the center of the container. The spacing device can have a number of different dielectric, conductive and physical structures, and may be designed to be disposable, recyclable or re-used as needed.

### CROSS REFERENCE TO RELATED APPLICATION(S)

The present application claims priority to and the benefit of U.S. provisional application No. 62/716,722 filed Aug. 9, 2018, which is incorporated herein by reference in its entirety.

### BACKGROUND

The present invention relates generally to a spacing device for insertion into a package or container of radio-frequency identification (“RFID”) tagged items and a method for improving the readability of said RFID tagged items. More specifically, the spacing device allows for the more efficient propagation of a radio frequency (“RF”) signal through a volume, such as a package or other container, containing a high number or density of RFID tagged items. The device and method of the present invention is particularly suitable for scanning items containing a large number of RFID tagged items that are in close proximity to each other, for example, a large number of relatively small products with RFID tags attached thereto and placed in a shipping container or high density box. Accordingly, the present specification makes specific reference thereto. However, it is to be appreciated that aspects of the present invention are also equally amenable to other like applications and devices.

Generally stated, radio-frequency identification is the use of electromagnetic energy to stimulate a responsive device (known as an RFID “tag” or transponder) to identify itself and, in some cases, provide additionally stored data in the tag. RFID tags typically include a semiconductor device commonly called the “chip” on which are formed a memory and operating circuitry, which is connected to an antenna. Typically, RFID tags act as transponders, providing information stored in the chip memory in response to a radio frequency interrogation signal received from a reader, also referred to as an interrogator. In the case of passive RFID devices, the energy of the interrogation signal also provides the necessary energy to operate the RFID tag device.

RFID tags are generally formed by connecting an RFID chip to some form of antenna. Antenna types are very diverse, as are the methods of constructing the same. One particularly advantageous method of making RFID tags is to use a strap, a small device with an RFID chip connected to two or more conductors that can be coupled to an antenna. The coupling of the conductors to the antenna can be achieved using a conductive connection, an electric field connection, magnetic connection or a combination of coupling methods.

RFID tags may be incorporated into or attached to articles to be tracked. In some cases, the tag may be attached to the outside of an article with adhesive, tape, or other means and, in other cases, the RFID tag may be inserted within the article, such as being included in the packaging, located within the container of the article, or sewn into a garment. Further, RFID tags are manufactured with a unique identification number which is typically a simple serial number of a few bytes with a check digit attached. This identification number is incorporated into the RFID tag during its manufacture. The user cannot alter this serial/identification number, and manufacturers guarantee that each RFID tag serial number is used only once and is, therefore, unique. Such read-only RFID tags typically are permanently attached to an article to be tracked and, once attached, the serial number of the tag is associated with its host article in a computer database.

Frequently, for operations such as shipping between locations, it is desirable to be able to identify and count the number of items in a carton or shipping container, without having to open the carton or container. Heretofore, using RFID tagged items within the carton or container has been a relatively effective solution to this problem. However, notwithstanding the many benefits of RFID technology and the many potential uses of RFID tags, one current limitation of current RFID tag designs relates to the inventorying of a shipping container, packaging or other volume containing a large number of RFID tag items in relatively close proximity to each other. More specifically, the close proximity of a relatively large number of RFID tag items in a confined space tends to make it difficult for the RFID reader or interrogator to successfully detect and interrogate 100% of the RFID tagged items due to potential interferences caused by the other RFID tagged items in close proximity thereto. For example, it has proven to be challenging to successfully read and identify a high percentage of the RFID tagged items within a carton or container with a hand held reader, or when a container is transitioned from storage to a shop floor, or even when a RFID tunnel reader is placed over a conveyor with the container thereon.

Another historic hurdle with successfully detecting and interrogating 100% of the RFID tagged items in a container is that the RFID tagged items have a variety of impacts on a RF field passing through the space that the RFID tags occupy. For example, obstruction and reflection from metallic items such as the RFID antennas and some products, as well as dielectric loss and reflection from the product structure itself can all impact the RF field passing through the carton of RFID tagged items.

Therefore, there exists in the art a long felt need to increase the percentage of RFID tagged items successfully detected and interrogated when a relatively large number of RFID tagged items are placed in a relatively confined space and in close proximity to one another. The present invention discloses a device that is useful for optimizing a RFID reader system to increase the percentage of RFID tags successfully inventoried. To achieve a greater percentage of successfully inventoried RFID tagged items, the present invention discloses a spacing device placed within the carton or container, wherein the spacing device can be varied to create different effects on the readability of the RFID tagged items by preventing them from occupying areas with a large amount of material between the RFID tagged item and the RFID reader.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a spacing device for improving readability of a container of RFID tagged items that are in close proximity to one other. The spacing device is preferably a relatively low dielectric constant device, wherein the nature of the spacing device can be varied by the user to create different effects on the readability of the RFID tagged items by preventing them from occupying areas with a large amount of material between the RFID tagged item and the RFID reader. The low dielectric constant spacing device consumes a space in the volume it is placed into, thereby reducing the density and the path or obstruction to the RFID tags positioned around the spacing device.

In an alternative embodiment of the present invention, a metal member or element is attached in or to the container in such a way that will permit the metal member to move or reposition relative to the container when the container is moved or repositioned, thereby altering or changing the field conditions within the container. The movement of the metal member within the container reduces or prevents nulls, defined as areas where RFID tags cannot be read or interrogated due to unfavorable RF propagation conditions within the container, and therefore increases the percentage of RFID tagged items being successfully read, with an ultimate goal of 100%.

In another embodiment of the present invention, a retro-reflective corner cube is placed within the container, which increases the probability of reading RFID tags along the vector between the RFID reader and the corner cube reflector. Alternatively, a far field antenna may be utilized, which receives RF energy and provides drive to one or more near field elements, then couples efficiently to RFID tags where the far field response is blocked. Furthermore, a rechargeable battery can be utilized to drive a reflection amplifier connected to an antenna. RF energy from an RFID reader or signal from a RFID tag is then re-radiated in an amplified form, thereby enhancing readability of local RFID tags and increasing the percentage of RFID tagged items being successfully read, with an ultimate goal of 100%.

The subject matter disclosed and claimed herein, in one aspect thereof, comprises a method of optimizing a RFID reader system to inventory a container containing a relatively large number of RFID tagged items that are in close proximity to one another. The method comprises positioning a transmitting system capable of reading an RFID tag outside of a container, such as a shipping container, and a spacing device, such as a metal member, a retro-reflective corner cube or other device with a relatively low dielectric constant, within the container. Further, the nature of the spacing device can be varied by the user to create different effects on the readability of the RFID tagged items in the container by preventing them from occupying areas with a large amount of material between the RFID tagged item and the RFID reader. More specifically, the low dielectric constant spacing device consumes a space in the volume it is placed into, thereby reducing the density and the path or obstruction to the RFID tags positioned around the spacing device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of a shipping container containing a plurality of RFID tagged items in close proximity to a RFID reader system in accordance with the disclosed architecture.

FIG. 2 illustrates a front perspective view of a shipping container containing a plurality of RFID tagged items and a spacing device, all in close proximity to a RFID reader system in accordance with the disclosed architecture.

FIG. 3A illustrates a front perspective view of a shipping container with a low dielectric constant in accordance with the disclosed architecture.

FIG. 3B illustrates a front perspective view of a shipping container containing a metal member in accordance with the disclosed architecture.

FIG. 4A illustrates a front perspective view of a shipping container containing a movable metal member in accordance with the disclosed architecture.

FIG. 4B illustrates a front perspective view of a shipping container containing a resonant reflector in accordance with the disclosed architecture.

FIG. 5A illustrates a front perspective view of a shipping container containing a movable ball-shaped reflector in accordance with the disclosed architecture.

FIG. 5B illustrates a front perspective view of a shipping container containing a corner cube reflector in close proximity to a RFID reader system in accordance with the disclosed architecture.

FIG. 6 illustrates a front view of a far field antenna in close proximity to a RFID reader system in accordance with the disclosed architecture.

FIG. 7 illustrates a front view of a reflection amplifier connected to an antenna in close proximity to a RFID reader system in accordance with the disclosed architecture.

FIG. 8 illustrates a front perspective view of an air luggage container containing RFID tagged luggage items and the spacing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

In one embodiment, the present invention discloses a device useful for optimizing the performance of a RFID reader system to increase the percentage of RFID tags successfully inventoried in a shipping container, high density box (HDB) or other container comprising a relatively large number of RFID tagged items in close proximity to one another with the ultimate goal being 100%. In one embodiment of the present invention, to achieve a greater percentage of successfully inventoried RFID tagged items in a container, a spacing device is utilized. The spacing device is preferably a low dielectric constant spacing device, wherein the nature of the spacing device can be varied by the user to create different effects on the readability of the RFID tagged items by preventing the RFID tags from occupying areas within the container with a large amount of material between the RFID tag and the RF reader system. More specifically, the relatively low dielectric constant spacing device consumes a space in the volume of the container that it is placed into, thereby reducing the density and the path or obstruction to the RFID tags positioned around the spacing device. The spacing device may be added into the container as the RFID tagged items are loaded therein, and is preferably positioned in the middle of the container. The spacing device of the present invention may also have a number of different dielectric, conductive and physical structures or properties, and may be designed to be disposable or re-used as needed to suit user preference.

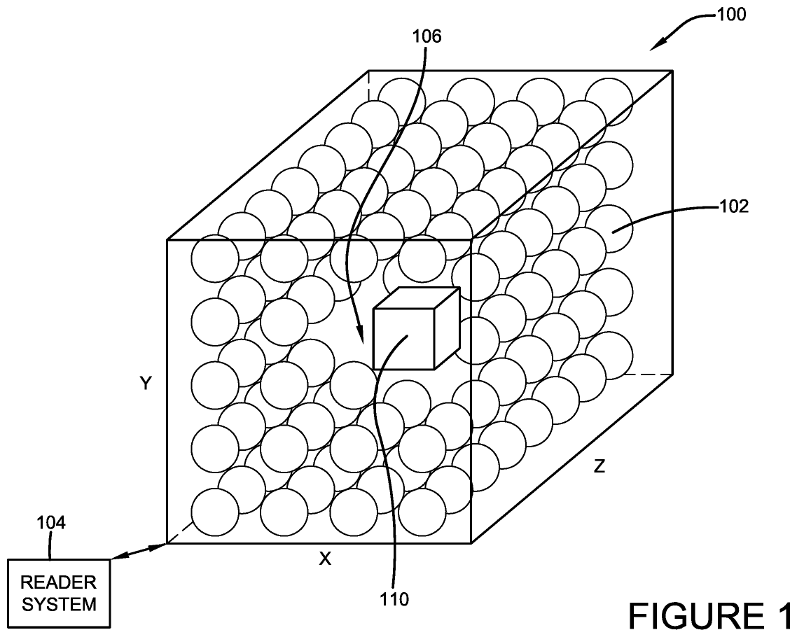

Referring initially to the drawings, FIG. 1 illustrates a front perspective view of a basic shipping box, carton or other container 100 or volume containing a plurality of RFID tagged items 102, which are in read proximity of, and presented to, a RF reader system 104. The container 100 can be any suitable container as is known in the art for housing, storing and/or transporting items, such as RFID tagged items 102. Further, container 100 can be any suitable size, shape, and/or configuration as is known in the art without affecting the overall concept of the invention. One of ordinary skill in the art will appreciate that the shape, size and configuration of the container 100 shown in FIG. 1 is for illustrative purposes only, and that many other shapes and sizes of the container 100 are well within the scope of the present disclosure. Although the dimensions of the container 100 (i.e., length, width, and height) are important design parameters for good performance, the container 100 may be any shape or size that ensures optimal performance during use.

Typically, package or container 100 will house or contain a relatively large number and/or a high density of RFID tagged items 102 in relatively close proximity to one another within the container 100, thus the container 100 can be referred to as a high density box (HDB) or other such nomenclature. Obviously, it is desirable when scanning or interrogating a box or container, such as container 100, to detect all of its contents or, in this case, 100% of RFID tagged items 102. However, as previously mentioned, heretofore it has been difficult for an interrogator or RFID reader system to successfully detect and interrogate 100% of the RFID tagged items 102 in container 100 due to potential interferences caused by the close proximity or relatively high density of RFID tagged items 102 in container 100.

Accordingly, the basic concept of one embodiment of the device of the present invention is to maximize the propagation of an RF signal through container 100 in an effort to successfully identify as many of the RFID tagged items 102 contained therein as possible. Thus, if the RF power propagated through the container 100 is maximized, the probability of reading the RFID tagged items 102 can be greatly increased. However, the RFID tagged items 102 have a variety of impacts on a RF field or power passing through the space that the RFID tagged items 102 occupy. For example, obstruction and reflection from metallic items, such as the RFID antennas and some of the products within the container 100, as well as dielectric loss and reflection from the product structure itself could occur. Another phenomenon that can occur is resonant absorption, where the RFID tagged items 102 themselves remove energy from the RF field.

Accordingly, those RFID tagged items 102 that have the greatest number of other items positioned between said RFID tagged items and the RFID read system 104 will have a lower probability of being read by the RFID reader system 104. Therefore, if a RF reader system can be applied from, for example, any of the six sides of a container 100, an optimal position would be in the middle of the container (considering each of the x, y, and z dimensions), wherein a maximum number of RFID tagged items 102 would be in a direct path. Accordingly, the present invention discloses a spacing device 110 positioned in the center point or middle 106 of the container 100. The spacing device 110 propagates an RF signal from the RFID reader system 104 through the container volume containing the high density of RFID tagged items 102 to inventory the RFID tagged items 102 within the container 100 with an ultimate goal of 100% of the RFID tagged items 102 being successfully read or interrogated. The spacing device 110 can have a number of different dielectric, conductive, and physical structures, and may be designed to be disposable or re-used as needed. Thus, the nature of the spacing device 110 can be varied to create different effects on the readability of the RFID tagged items 102 by preventing the RFID tagged items 102 from occupying areas where there would be a large amount of material or items between the RFID tagged items 102 and the RFID reader system 104 that could interfere with the RF signal.

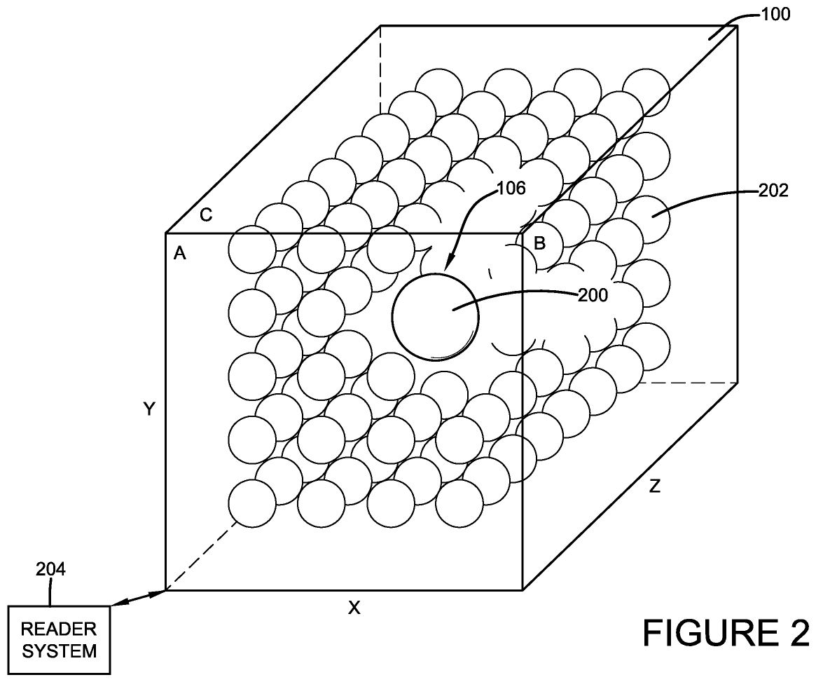

FIG. 2 illustrates a front perspective view of a shipping container 100 containing a plurality of RFID tagged items 202 and a spacing device 200, all in close proximity to a RFID reader system 204. More specifically, the spacing device 200 is positioned in the middle 106 of the shipping container 100 occupying a defined volume and communicating with the RF reader system 204, which is located outside of, but in relatively close proximity to, the container 100. Typically, the spacing device 200 is added into the container 100 as the RFID tagged items 202 are loaded into the container. As previously mentioned, spacing device 200 can have a number of different dielectric, conductive, and physical structures (e.g., a bar code or other type of code), and may be designed to be disposable, recyclable, or re-used as needed. Therefore, the nature of the spacing device 200 can be varied to create different effects on the readability of the RFID tagged items 202 by preventing the RFID tagged items 202 from occupying areas where there would otherwise be a large amount of material between the RFID tagged items 202 and the RFID reader system 204 that could interfere with the RF signal or field.

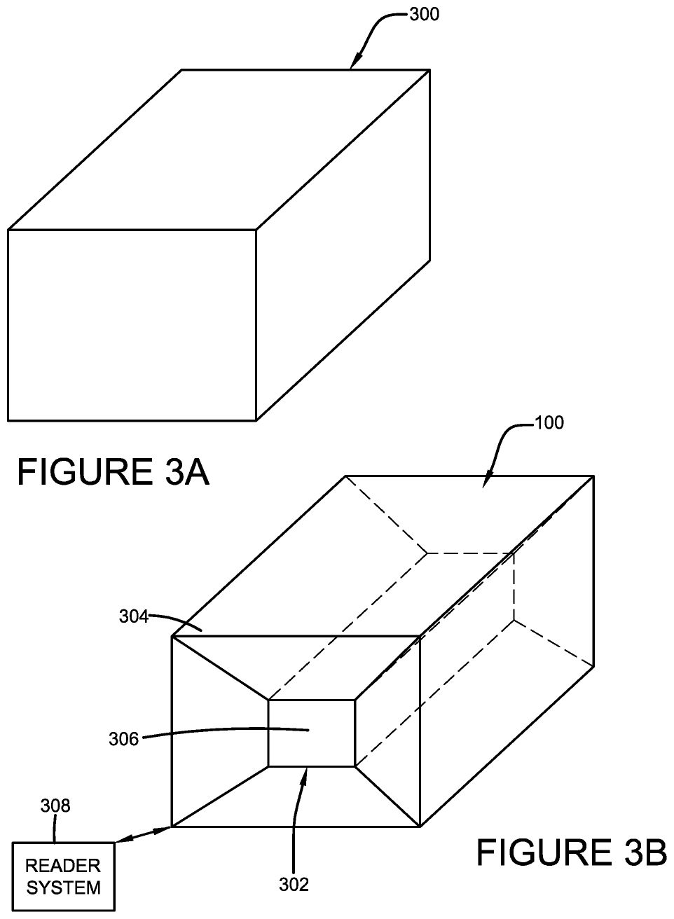

FIG. 3A illustrates an alternative embodiment of the present invention and is a front perspective view of a shipping container 300 having a low dielectric constant. More specifically, low dielectric constant container 300 may be, by way of example, an air-filled box, foamed plastic or other suitable material, such as air-filled packaging materials like the flexible sheet material commonly known or described as ‘bubble wrap’. The use of a low dielectric constant material, such as bubble wrap, consumes a space in the container volume that it is placed into, thereby reducing the density and the path or obstruction of the RFID signal to the RFID tagged items placed around it.

FIG. 3B illustrates a further alternative embodiment of the present invention and is a front perspective view of a shipping box or container 100 containing a metal member or component 302. The metal component 302 can be comprised of any suitable metal as is known in the art, such as a foil layer, etc. The metal component 302 is preferably positioned in the middle of container 100 (considering all three dimensions) such that there is a space between the surfaces 304 of container 100 and the surfaces 306 of the metal component 302 in each dimension. In a preferred embodiment of the present invention, the spacing of the surfaces 306 of the metal component 302 relative to the surfaces 304 of container 100 is approximately one quarter wavelength at the operating frequency of the RFID reader system 308 to act as a reflector, and to direct the antenna radiation pattern of RFID tagged items (not shown) in container 100 outwards toward the RFID reader system 308. It will be appreciated by one of ordinary skill in the art that the required spacing may be determined by the dielectric constant of the material between the surfaces 306 of the metal component 302 and the surfaces 304 of the container 100. By way of example, a material with a relative dielectric constant of 4.0 will reduce the distance required to form a quarter wavelength reflector by a factor of two.

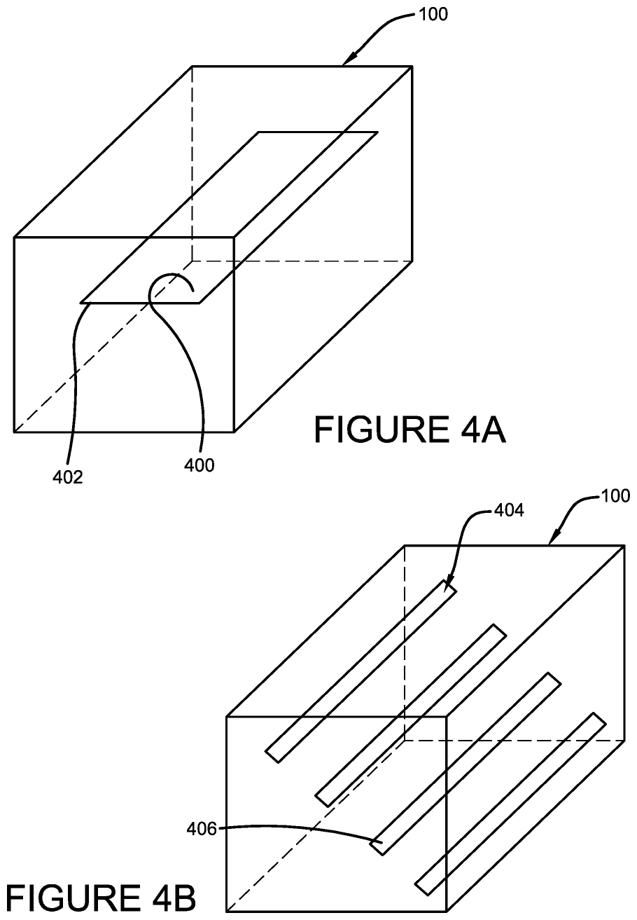

FIG. 4A illustrates a further alternative embodiment of the present invention and is a front perspective view of a shipping box or container 100 containing a movable metal member or component 400. For example, metal component 400 may be a sheet or resonant scattering element, for example a half wavelength at the operating frequency of an RFID reader system. The metal component 400 can be any suitable metal as is known in the art, such as a foil layer, etc. The metal component 400 is preferably attached in the container 100 in such a way that the metal component 400 will move or reposition relative to container 100 when container 100 is moved or repositioned, thereby changing the RF field conditions within the container 100. The form of fixing or attaching the metal component 400 to container 100 can be any suitable attachment means as is known in the art, and that suits the wants or needs of the user. For example, metal component 400 may comprise an edge or edges 402 that may be attached to container 100 in a manner that will permit the remainder of metal component 400 to move relative to the container 100 when the container is moved or repositioned.

Furthermore, the metal component 400 may also be elastic so that the metal component 400 continues to move after a mechanical input, such as the container 100 starting to move. The movement of the metal component 400 prevents nulls, which are areas where RFID tags cannot be read or interrogation due to propagation conditions within the container 100. For example, the RF signals coming to the RFID tags from an RFID reader system (not shown) along two paths are 180 degrees out of phase, so they cancel each other out. However, the movement of the metal component 400 within container 100 prevents a null from being continuously present, and therefore improves the probability of the associated RFID tag or RFID tagged items being successfully read, with an ultimate goal of 100% of the RFID tagged items being successfully read.

Additionally, as shown in FIG. 4B, an alternative form of a reflector 404 or plurality of reflectors with one or more degrees of movement as described above in FIG. 4A can be utilized. More specifically, a reflector 404 may be attached to the container 100 in such a manner that the reflector 404 will move in relation to container 100 and/or one or more other reflectors 404, when the container 100 is moved or repositioned, thereby changing the RF field conditions within the container 100. The form of fixing or attaching the metal reflector(s) 404 to container 100 can be any suitable attachment means as is known in the art, and that suits the wants or needs of the user. For example, metal reflector(s) 404 may comprise an edge or edges 406 that may be attached to container 100 in a manner that will permit the remainder of metal reflector 404 to move relative to the container 100 and/or other metal reflector(s) 404 when the container is moved or repositioned.

Furthermore, the metal reflector 404 may also be elastic so that the metal reflector 404 continues to move after a mechanical input, such as the container 100 starting to move. The metal reflector 404 can also be made of any suitable reflective material as is known in the art. Further, the metal reflector 404 is resonant at or near to the RFID reader system frequency. As described above, a plurality of individual reflectors 404 may be used, or the reflector 404 may consist of a series of strips of a defined proportion of the wavelength, for example halt or any other suitable size or shape as is known in the art.

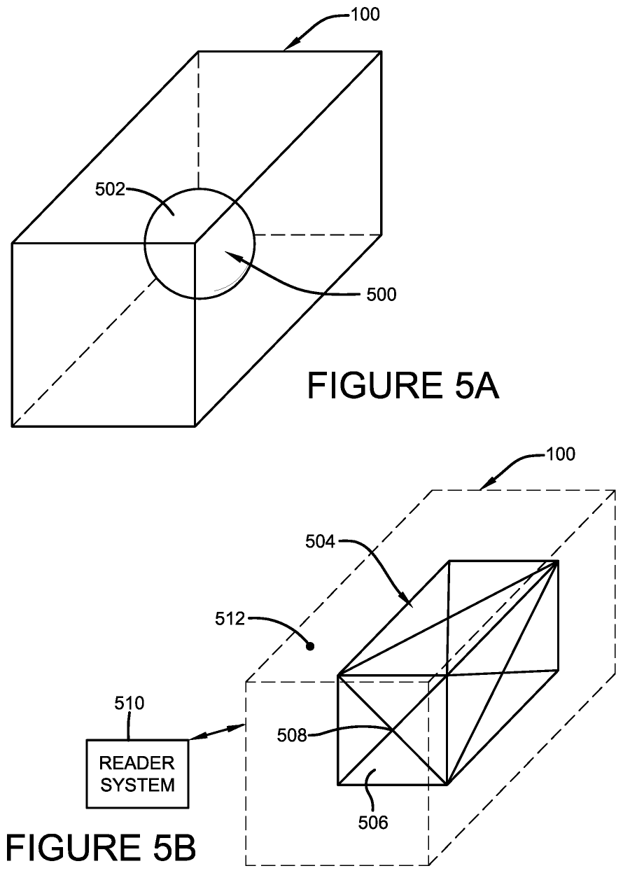

FIG. 5A illustrates a further embodiment of the present invention and a front perspective view of a shipping container 100 containing a movable ball-shaped reflector 500 having a surface 502. Ball or sphere shaped reflector 500 is another simple form of a movable reflector and may be comprised of a dielectric, metallic, or combination material which, as previously described, is free to move. More specifically, the ball shaped reflector 500 is attached in the container 100 in such a way that the reflector 500 will move when the container 100 is moved, thereby changing the RF field conditions within the container 100. The form of fixing (or attachment) of reflector 500 to container 100 can be any suitable attachment means as is known in the art and may, for example, be attached at the surface 502 depending on the wants and/or needs of a user. Furthermore, the ball or spherical shaped reflector 500 may also be elastic so that the reflector 500 continues to move after a mechanical input, such as the container 100 starting to move.

FIG. 5B illustrates yet another embodiment of the present invention and a front perspective view of a shipping container 100 containing a corner cube reflector 504 in close proximity to a RFID reader system 510 in accordance with the disclosed architecture. More specifically, each face 506 of corner cube 504 is composed of an inverted pyramid 508 of a conductor from the center to the edge of the container 100. The corner cube reflector 504 can be made of any suitable reflective material as is known in the art. This corner cube structure is retro-reflective and, therefore, any RF energy incident on the corner cube 504 is reflected back to the RF source along the same vector it came in on. This enhancement to the RF interrogation path increases the probability of RFID tags 512 along or adjacent to the vector between the RFID reader system 510 and corner cube reflector 504 being successfully read or interrogated. It will be appreciated by those skilled in the art that other retro-reflective RF structures are possible, such as a Van Atta array, but that the retro-reflective corner cube 504, and single face versions of the same, is a preferred embodiment due to its simplicity.

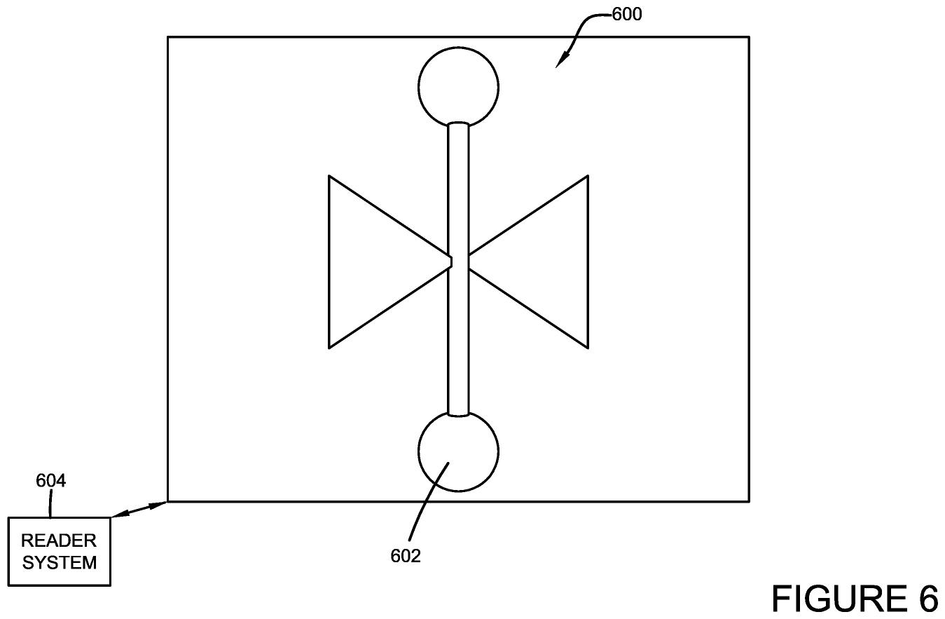

As shown in FIG. 6, an alternative embodiment of a far field to near field passive converter device is disclosed. More specifically, a far field antenna 600 which receives RF energy from an RF reader system 604, and provides drive to one or more near field elements 602 is utilized. For example, loops generate a localized H field that can couple efficiently to RFID tags where the far field response is blocked. It will be appreciated that the far field antenna 600 inherently allows RF signals to pass both ways so, for example, the far field antenna 600 will carry RF energy to a RFID tag but will also carry its response back to the RFID reader system 604.

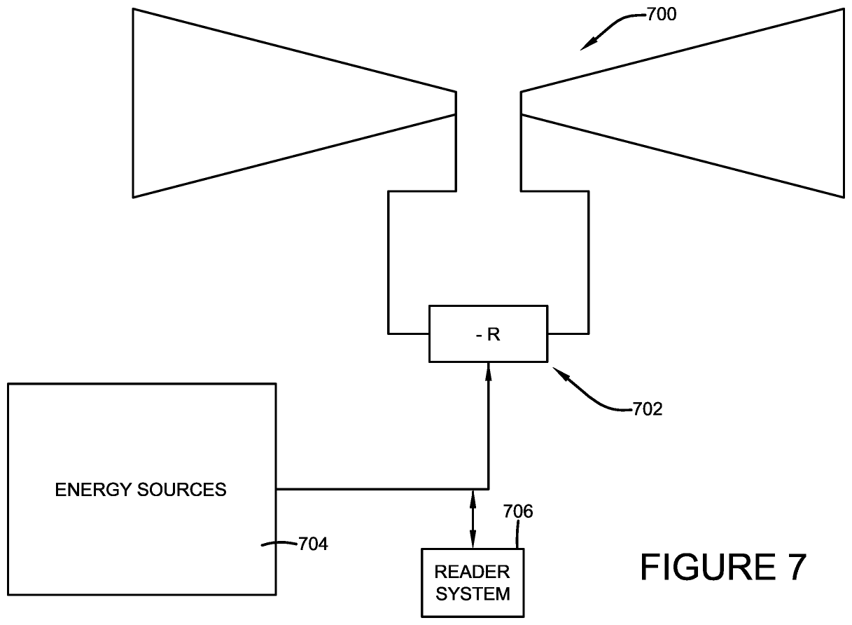

As shown in FIG. 7, a local field booster (antenna) 700 using a reflection amplifier device 702 that is active and designed to enhance readability is utilized. Specifically, a power harvesting energy source 704, for example a rechargeable battery, super-capacitor, photovoltaic, or movement generator, or any other suitable energy source as is known in the art, drives a reflection amplifier device 702 connected to an antenna (local field booster 700). RF energy from an RFID reader system 706 or RF signal from an RFID tag incident on the antenna (local field booster 700) is re-radiated in an amplified form, thereby enhancing readability of the local RFID tags.

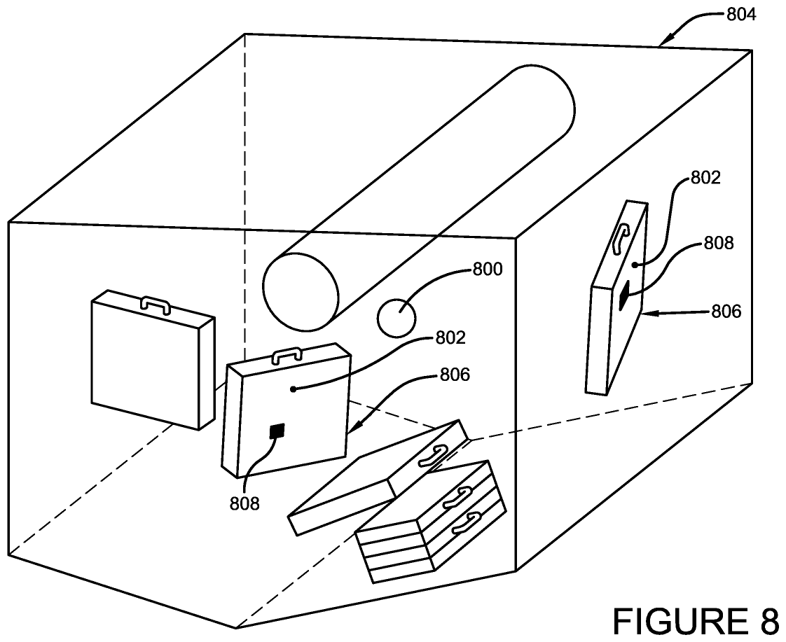

FIG. 8 illustrates a front perspective view of an air luggage container containing RFID tagged luggage items and the spacing device 800 of the present invention in accordance with the disclosed architecture. More specifically, the spacing device 800 and system is not limited to the shipping of RFID tagged retail items, but can also be applied to any structure or container where there are a large number of RFID tagged items 802 in relatively close proximity to one another in a container 804. For example, a spacing device 800 could be placed into a container 804 of luggage 806 to be shipped on an aircraft, ship, rail car, etc. The nature of the spacing device 800 could be any of those embodiments described previously, designed to enhance readability of the RFID tagged luggage 806. For ease of handling, the spacing device 800 may be in the form of a piece of luggage 806 itself, and have its own RFID tag 802 and, if required, a bar-code 808, used to ensure that the spacing device 800 is tracked and not lost so it can be re-used.

It will be appreciated that the adaptation of the spacing device may be a continuous process as a container passes the scanning area to allow compensation for the movement relative to the spacing device and any other structure nearby such as the walls of a tunnel reader system, while adapting to achieve the maximum RF transmission through the container and highest possible read accuracy for the RFID tags in the container, with an ultimate goal of 100% of RFID tagged items being successfully read or interrogated. Further, the initial setting and embodiments of the spacing device may be based on learned optimums from previous scanning operations and adapted based on the initial starting state.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for improving radio frequency (RF) readability of a volume of RFID tagged items comprising:
a container containing the volume of RFID tagged items;
a spacing device positioned inside the container; and
a reader system positioned outside of the container.

2. The system of claim 1, wherein the spacing device is positioned in a middle of the container.

3. The system of claim 1, wherein the spacing device has a low dielectric constant.

4. The system of claim 1, wherein the spacing device is a metal component and further wherein a space exists between a surface of the spacing device and a surface of the container.

5. The system of claim 1, wherein the spacing device is attached to the container.

6. The system of claim 1, wherein the spacing device is a substantially spherical-shaped reflector.

7. The system of claim 1, wherein the spacing device is a corner cube reflector.

8. The system of claim 1 further comprising a far field antenna.

9. The system of claim 1 further comprising a reflection amplifier.

10. A system for improving radio frequency (RF) readability of a volume of RFID tagged items comprising:
a container containing the volume of RFID tagged items;
a spacing device positioned inside the container that propagates an RF signal; and
a reader system positioned outside of the container for generating and receiving the RF signal.

11. The system of claim 10, wherein the spacing device is positioned in a middle of the container.

12. The system of claim 10, wherein the spacing device has a low dielectric constant.

13. The system of claim 10, wherein the spacing device is attached to the container in such a manner that a portion of the spacing device moves relative to the container when the container is moved.

14. The system of claim 10, wherein the spacing device comprises a bar-code.

15. The system of claim 10, wherein the spacing device is a corner cube reflector and further wherein at least one face of the corner cube reflector has an inverted pyramid thereon.

16. The system of claim 10 further comprising a far field antenna.

17. The system of claim 10 further comprising a reflection amplifier.

18. A method of optimizing radio frequency (RF) read technology for a container of RFID tagged items comprising:
using an RF transmitting system to propagate an RF signal through the container;
using a spacing device within said device to further propagate the RF signal within the container; and
inventorying the RFID tagged items in the container.

19. The method of claim 18, wherein the spacing device is comprised of a relatively low dielectric constant.

20. The method of claim 10, wherein the spacing device is attached to the container and is further comprised of one of the following: (a) a substantially spherical-shaped reflector;
(b) a bar code; (c) a corner cube reflector; (d) a resonant reflector; and (e) a metal component.
